(19) United States
(12) Patent Application Publication
(10) Pub. No.: US 2026/0319399 A1
(43) Pub. Date: Oct. 15, 2026

(54) BELT CLEANER AND IMAGE FORMING APPARATUS

(71) Applicant: Haruki Nagata, Kanagawa (JP)

(72) Inventor: Haruki Nagata, Kanagawa (JP)

(73) Assignee: Ricoh Company, Ltd., Tokyo (JP)

(21) Appl. No.: 19/633,819

(22) Filed: Mar. 30, 2026

(30) Foreign Application Priority Data
Apr. 9, 2025 (JP) 2025-064182

(51) Int. Cl. G03G 15/16; A46B 13/00; A46B 13/02; G03G 15/01

(52) U.S. Cl. CPC G03G 15/161; A46B 13/001; A46B 13/02; G03G 15/0131; G03G 15/0189; G03G 15/1615; A46B 2200/3073

(57) ABSTRACT

A belt conveyor includes multiple rollers including a predetermined roller; a belt wound around the multiple rollers, the belt traveling in a traveling direction; a scale on an inner peripheral face of the belt, the scale disposed in a vicinity of an end of the belt in a width direction orthogonal to the traveling direction, a detector to detect the scale on the belt; circuitry configured to control a traveling speed of the belt by reflecting an output from the detector; a first cleaner on the predetermined roller, around which the belt is wound at an angle of 90 degrees or more, and the first cleaner contacting the scale to clean the scale; and a second cleaner: facing the first cleaner via the belt; and contacting an outer peripheral face of the belt to clean the outer peripheral face.

### CROSS-REFERENCE TO RELATED APPLICATIONS

This patent application is based on and claims priority pursuant to 35 U.S.C. § 119(a) to Japanese Patent Application No. 2025-064182, filed on Apr. 9, 2025, in the Japan Patent Office, the entire disclosure of which is hereby incorporated by reference herein.

### BACKGROUND

### Technical Field

The present embodiment relates to a belt cleaner and an image forming apparatus.

### Related Art

An electrophotographic image forming apparatus that forms an image on a recording medium sometimes includes a belt device such as a transfer unit or a conveyance unit including a belt of an endless shape wound around multiple rollers as a transfer body or a conveyance body of the recording medium. In such a belt device, in order to control the moving speed of the belt (conveying speed of the recording medium), there is a configuration in which a tape-shaped scale, which is read by an optical detector, is attached to at least one side in a belt width direction orthogonal to the belt moving direction over the belt longitudinal direction (full length direction).

As an example of this, there is a technique in which a scale tape as a scale is attached to the back surface of the intermediate transfer belt, and the scale tape is optically read to control the position and speed of the intermediate transfer belt with high accuracy. The scale tape has slits and irregularities on a surface thereof, and such slits and irregularities are detected by an optical detector. However, in this configuration, there is a disadvantage that contamination such as toner adheres to the optical sensor as the optical detector or toner contamination adheres to the scale tape itself, and thus the scale tape cannot be optically read.

Therefore, there are a technique in which a rotating brush with bristles implanted on a roller that stretches the belt is disposed on the upstream side of the optical sensor to clean the scale tape, and a technique in which the belt is sandwiched by a bracket provided with a front and back integrated brush disposed on the downstream side of the optical sensor to clean the scale tape.

### SUMMARY

The present disclosure described herein provides a belt conveyor includes multiple rollers including a predetermined roller; a belt wound around the multiple rollers, the belt traveling in a traveling direction; a scale on an inner peripheral face of the belt, the scale disposed in a vicinity of an end of the belt in a width direction orthogonal to the traveling direction, a detector to detect the scale on the belt; circuitry configure to control a traveling speed of the belt by reflecting an output from the detector; a first cleaner on the predetermined roller, around which the belt is wound at an angle of 90 degrees or more, and the first cleaner contacting the scale to clean the scale; and a second cleaner: facing the first cleaner via the belt; and contacting an outer peripheral face of the belt to clean the outer peripheral face.

### BRIEF DESCRIPTIONS OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic front view of an image forming apparatus;

FIG. 2 is a schematic view illustrating a configuration of a belt conveyor;

FIG. 3 is a schematic perspective view of an intermediate transfer belt, a roller, and a scale of the belt conveyor as viewed from the inside of the intermediate transfer belt;

FIG. 4 is a schematic cross-sectional view illustrating a configuration of an intermediate transfer belt and a scale;

FIG. 5 is a schematic view illustrating a configuration of a detector;

FIGS. 6A to 6C are schematic views illustrating the configuration of the detector;

FIG. 7 is a schematic view illustrating a configuration at a joint of a scale provided in an intermediate transfer belt;

FIG. 8 is a schematic view illustrating a scale tape and a scale sensor;

FIG. 9 is a schematic front view illustrating a belt cleaner;

FIG. 10 is a schematic view illustrating a first cleaner of the belt cleaner;

FIG. 11 is a schematic view illustrating the first cleaner of the belt cleaner;

FIG. 12 is a schematic view illustrating the first cleaner and the second cleaner of the belt cleaner;

FIG. 13 is a schematic view illustrating the first cleaner and the second cleaner of the belt cleaner;

FIG. 14 is a schematic view illustrating the second cleaner and a support bracket of the belt cleaner;

FIG. 15 is a schematic view illustrating a winding angle of the belt with respect to a predetermined roller of the belt cleaner;

FIG. 16 is a diagram for explaining a method of attaching and detaching a belt of the belt cleaner; and

FIG. 17 is a diagram for explaining the method of attaching and detaching the belt of the belt cleaner.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

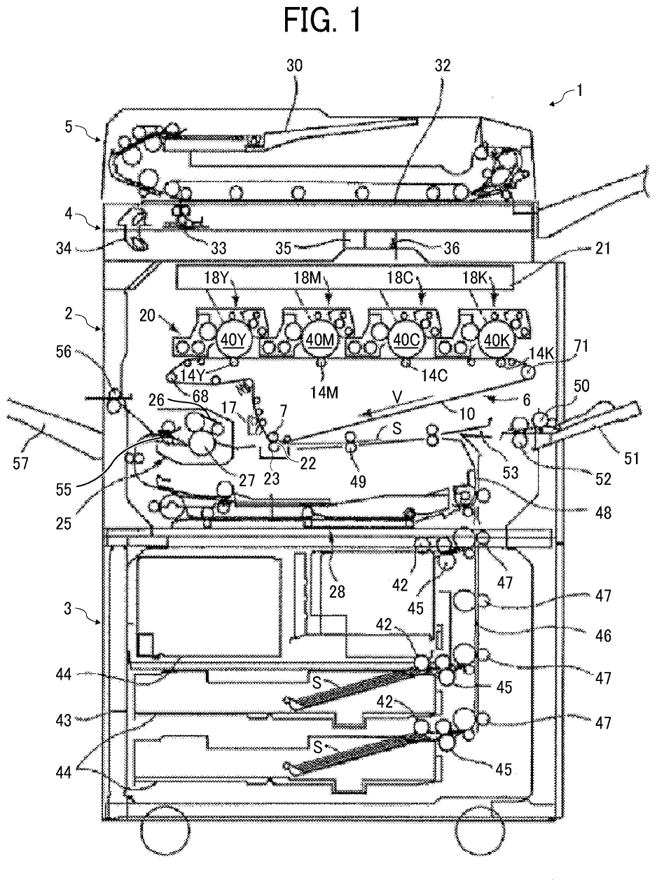

FIG. 1 illustrates an image forming apparatus of the present embodiment. In the drawing, an electrophotographic color copying machine 1 which is an image forming apparatus includes an apparatus body 2, a sheet feeding table 3 on which the apparatus body 2 is placed, a scanner 4 which is an image reader attached to an upper portion of the apparatus body 2, and an automatic document feeder (ADF) 5 attached to an upper portion of the scanner 4.

An intermediate transfer unit 6 as a belt conveyor including an intermediate transfer belt 10 which is a belt of an endless shape is disposed at the center of the apparatus body 2. The intermediate transfer belt 10 is stretched around multiple rollers, and is driven to travel in a clockwise direction which is a belt traveling direction indicated by reference sign V in FIG.
1. The intermediate transfer belt 10 may also be simply referred to as a “belt”.

A transfer cleaning device 17 that removes residual toner remaining on the intermediate transfer belt 10 after image transfer to a recording medium is disposed around the intermediate transfer belt 10. Above the intermediate transfer unit 6, four process cartridges 18Y, 18M, 18C, and 18K corresponding to respective colors of yellow, magenta, cyan, and black are arranged in this order from the upstream side along a belt traveling direction V. The process cartridges 18Y, 18M, 18C, and 18K constitute a tandem image forming section 20. Above the tandem image forming section 20, an exposure device 21 is disposed.

The process cartridges 18Y, 18M, 18C, and 18K include drum-shaped photoconductors 40Y, 40M, 40C, and 40K as image bearers, and have a function of forming toner images on the photoconductors 40 using toners of respective colors by a known electrophotographic process and cleaning the surface of the photoconductor after the toner images are transferred. The process cartridges 18Y, 18M, 18C, and 18K and the intermediate transfer unit 6 are detachably supported by the apparatus body 2. The drum-shaped photoconductors 40Y, 40M, 40C, and 40K may also be simply referred to also as “photoconductors”

A secondary transfer roller 23, which is a secondary transfer member, is disposed at a position facing the tandem image forming section 20 via the intermediate transfer unit 6. The secondary transfer roller 23 is pressed against the secondary transfer opposing roller 7 which is a secondary transfer opposing member via the intermediate transfer belt 10, and forms a nip portion 22 which is a secondary transfer portion at a contact portion of both rollers. In the nip portion 22, a transfer bias is applied to the secondary transfer opposing roller 7 or the secondary transfer roller 23, whereby the toner image or the composite color image on the intermediate transfer belt 10 is transferred to a transfer sheet S as a recording medium.

A fixing device 25 that fixes the toner image transferred to the transfer sheet S is disposed on a downstream side of the secondary transfer roller 23 in the sheet conveyance direction. The fixing device 25 is constituted by pressing a pressure roller 27 as a pressure member against a fixing belt 26 as a fixing member.

As the secondary transfer opposing member, a member obtained by winding an endless belt around multiple rollers may be used instead of the secondary transfer opposing roller 7. In the present embodiment, a contact method in which the secondary transfer roller 23 is brought into contact with the intermediate transfer belt 10 is adopted, but a non-contact charger may be disposed as a secondary transfer member. In such a case, it is difficult to provide a sheet conveying function using a roller or a belt together, and thus conveying module such as a roller or a belt may be individually disposed.

In the configuration illustrated in FIG. 1, below the nip portion 22 and the fixing device 25, a sheet reversing device 28 that reverses the transfer sheet S to form images on both sides of the transfer sheet S is disposed in parallel with the tandem image forming section 20, and double-sided image forming is possible. The color copying machine 1 may be arranged to be connectable to an external terminal device such as a personal computer in a wired or wireless manner to function as a printer.

In order to obtain a color output using the color copying machine 1 having such a configuration, first, a color document is set on the document table 30 of the automatic document feeder 5, or the automatic document feeder 5 is opened to set a color document on a contact glass 32 of the scanner 4, and then the automatic document feeder 5 is closed to press the document.

When the start switch of the color copying machine 1 is turned on, the scanner 4 is operated to cause the first traveling body 33 and the second traveling body 34 to travel after a document is conveyed and moved onto the contact glass 32 if the document has been set in the automatic document feeder 5, or immediately after a document is set on the contact glass 32. In the color copying machine 1, light is emitted from a light source by the first traveling body 33, reflected light from the document surface is further reflected and emitted toward the second traveling body 34, and the emitted light is reflected by a mirror of the second traveling body 34 and sent to a reading sensor 36 via an imaging forming lens 35, and the document content is read.

When the start switch is turned on, a drive motor described later is operated and the intermediate transfer belt 10 is driven to travel toward the belt traveling direction V. At the same time, the photoconductors 40Y, 40M, 40C, and 40K included in the process cartridges 18Y, 18M, 18C, and 18K are rotationally driven, and single-color toner images of yellow, magenta, cyan, and black are formed on the photoconductors 40, respectively. In the color copying machine 1, the single-color toner images formed along with the conveyance traveling of the intermediate transfer belt 10 are sequentially superimposed and transferred onto the intermediate transfer belt 10 to form a composite color image on the intermediate transfer belt 10.

When a start switch is turned on, one of the sheet feeding rollers 42 provided on the sheet feeding table 3 is selectively rotationally driven, and the transfer sheet S is fed from one of the multiple sheet feeding cassettes 44 provided in a paper bank 43. The fed transfer sheets S are separated one by one by a separation roller 45, sent to the sheet feeding path 46, conveyed by multiple conveyance rollers 47, sent to a sheet feeding path 48 in the apparatus body 2, and abutted against a registration roller pair 49 to be temporarily stopped. Alternatively, the sheet feeding roller 50 on a manual sheet feeding tray 51 is rotationally driven to feed the transfer sheet S, and the fed transfer sheets S are separated one by one by the separation roller 52 and sent to the manual sheet feeding path 53, and then are abutted against the registration roller pair 49 and temporarily stopped.

Then, the registration roller pair 49 is rotationally driven in accordance with the timing at which the composite color image on the intermediate transfer belt 10 reaches the nip portion 22, the transfer sheet S is sent to the nip portion 22 between the intermediate transfer belt 10 and the secondary transfer roller 23, and the composite color image on the intermediate transfer belt 10 is collectively transferred onto the transfer sheet S at the nip portion 22. In the case of obtaining a single-color output, a single-color toner image is formed and transferred onto the intermediate transfer belt 10, and the single-color toner image is transferred onto the transfer sheet S in the nip portion 22.

The transfer sheet S after the image transfer is sent from the nip portion 22 to the fixing device 25, and the image transferred by heat and pressure is fixed in the fixing device 25. Thereafter, a conveyance direction is determined by a switching claw 55, and the transfer sheet S is discharged to the outside of the apparatus by the discharge roller 56 and stacked on the sheet ejection tray 57. Alternatively, the conveyance direction is switched by the switching claw 55, the transfer sheet S is sent to the sheet reversing device 28, and after the front and back sides are reversed, the transfer sheet S is sent to the nip portion 22 again, the image is transferred to the back side, and then the transfer sheet S is stacked on the sheet ejection tray 57 by the discharge roller 56.

The intermediate transfer belt 10 after the image transfer is cleaned by the transfer cleaning device 17 for the residual toner to be removed, and is prepared for the image forming again.

The intermediate transfer belt 10 used in the present embodiment includes polyvinylidene fluoride (PVDF), ethylene-tetrafluoroethylene copolymer (ETFE), polyimide (PI), polycarbonate (PC), or the like that are formed into a single layer or multiple layers. Note that the surface of the intermediate transfer belt 10 may be coated with a release layer as necessary. As the intermediate transfer belt 10, an elastic belt having a rubber layer may be used. Using the elastic belt causes the intermediate transfer belt 10 to be crushed at the nip portion 22, so that a gap can be filled even with the transfer sheet S having irregularities, and thus transferability can be improved. In addition, since elongation of the belt becomes large with the rubber layer, as the intermediate transfer belt 10, a resinous layer such as a polyimide layer (PI layer) may be provided on the base layer, and a layer having a low friction coefficient may be further provided on the surface layer.

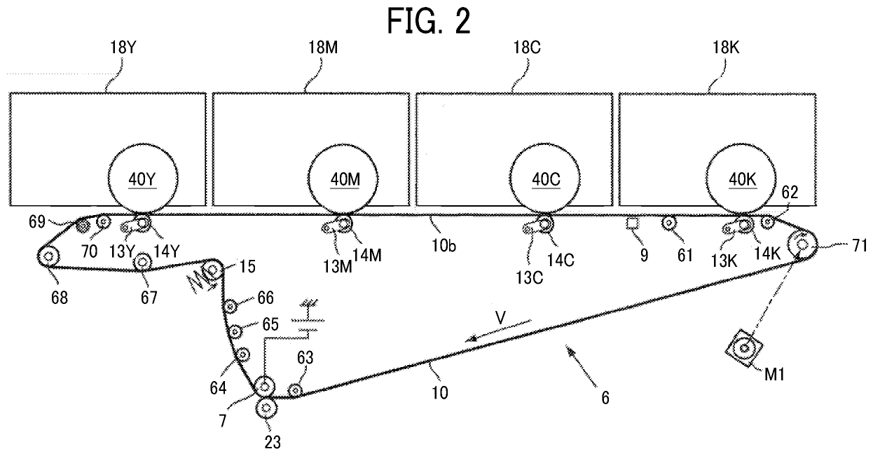

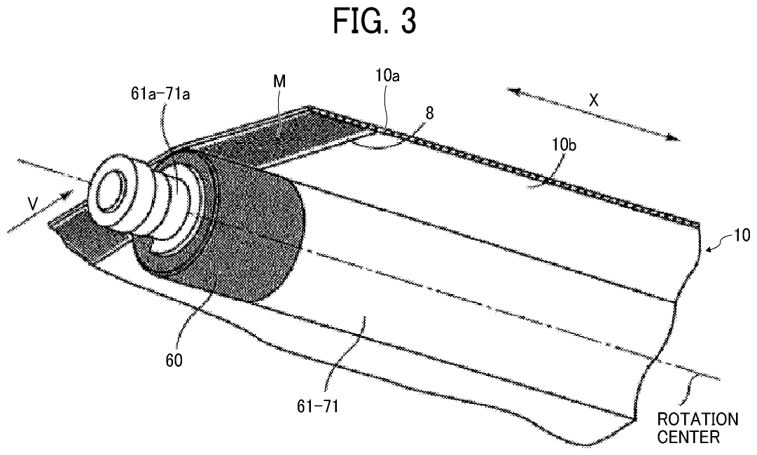

FIG. 2 is a schematic view of each process cartridge 18 and the intermediate transfer unit 6 as viewed from the front side of the apparatus body 2. The intermediate transfer unit 6 includes multiple rollers 61 to 71 and a secondary transfer opposing roller 7, and the intermediate transfer belt 10 wound around the rollers 7 and 61 to 71. The rollers 61 to 71 are mounted on the outer peripheries of the roller shafts 61a to 71a as illustrated in FIG. 3, and rotate integrally with the roller shafts 61a to 71a. Among the multiple rollers, the roller 71 and the roller 68 are disposed on a right end side and a left end side of the apparatus body 2, respectively. In the present embodiment, the roller is arranged as a driving roller 71 which is a driver, and the rollers 61 to 70 are configured as driven rollers. The roller 71 is rotationally driven clockwise in FIG. 2 by a drive motor M1 which is a drive source, and this drive causes the intermediate transfer belt 10 to be driven to travel in the belt traveling direction V at a predetermined speed.

The intermediate transfer belt 10 faces the photoconductors 40Y, 40M, 40C, and 40K on the upper side wound between the roller 71 and the roller 68. A tension roller 15 that presses the intermediate transfer belt 10 from the outside toward the inside is disposed between the roller 66 and the roller 67. The tension roller 15 is arranged as an elastic roller including a rubber layer on the outer periphery of a cored bar.

The secondary transfer opposing roller 7 is a rubber roller including a rubber layer on an outer periphery of a cored bar, and is arranged such that a secondary transfer bias is applied to a portion which is the cored bar. In the present embodiment, a secondary transfer bias subjected to constant current control is applied.

Primary transfer rollers 14Y, 14M, 14C, and 14K are disposed at positions inside the upper side of the intermediate transfer belt 10 and facing the photoconductors 40Y, 40M, 40C, and 40K, respectively. The primary transfer rollers 14Y, 14M, 14C, and 14K are rotatably supported by support arms 13Y, 13M, 13C, and 13K that swing in the vertical direction in the figure by a known contact-separation mechanism, and are arranged such that each primary transfer roller 14 comes into contact with and separates from the intermediate transfer belt 10 by adjusting the angle of each support arm 13 with an electric actuator, a cam, or the like.

Each primary transfer roller 14 is a rubber roller including a rubber layer on the outer periphery of a cored bar, and a primary transfer bias is applied to each cored bar portion. In the present embodiment, a primary transfer bias subjected to constant current control is applied.

As illustrated in FIG. 3, on an inner surface 10b of the intermediate transfer belt 10, the inner surface 10b facing each roller at an end 10a which is at least one side in the belt width direction X intersecting the belt traveling direction V, a scale tape 8 as a scale is disposed over the entire area in the belt longitudinal direction.

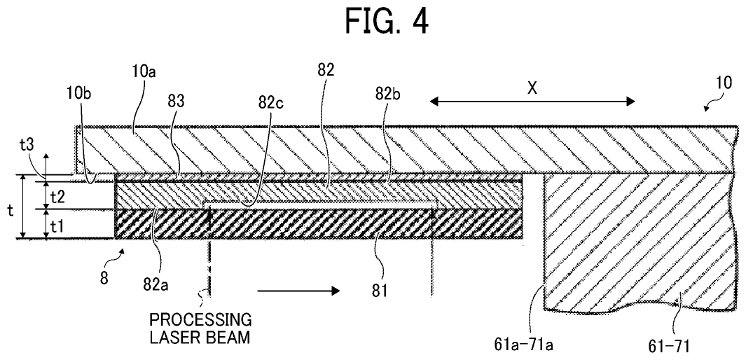

As illustrated in FIG. 4, the scale tape 8 has a three-layer structure in which a protective layer 81 having an insulating property, a metal layer 82 having electric conductivity, and an adhesive layer 83 are laminated. The scale tape 8 is bonded and secured to the inner surface 10b of the intermediate transfer belt 10 by adhesive force of the adhesive layer 83, and is integrated with the intermediate transfer belt 10. The metal layer 82 having electric conductivity is a metal vapor deposition film that is formed by vapor deposition of metal having electric conductivity such as aluminum on an insulating film made of, for example, polyethylene terephthalate (PET), the insulating film constituting a protective layer 81 and having an insulating property. The scale tape 8 is provided with the protective layer 81 on one surface 82a of the metal layer 82, and is provided with an adhesive layer 83 on the other surface 82b of the metal layer 82. Note that in FIG. 4, each layer is exaggerated in order to describe the configuration of the scale tape 8.

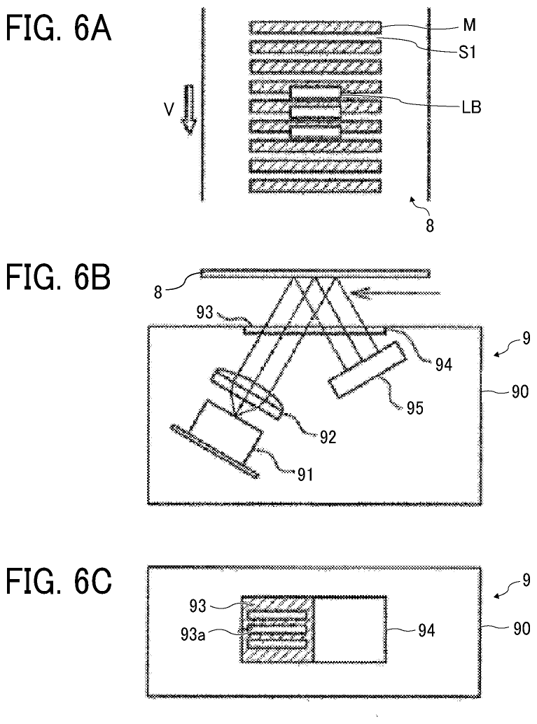

In the scale tape 8, the metal layer 82 is irradiated with a processing laser beam from the protective layer 81 side by, for example, a laser processing machine or the like, so that an uneven portion 82c in which the metal layer 82 is partially melted is formed. As illustrated in FIGS. 4 and 6A, the uneven portions 82c are disposed in parallel to each other with the same length, at equal intervals, and at an extremely small pitch along the belt traveling direction V, and are provided on the entire circumference of the intermediate transfer belt 10 to constitute a scale mark M that causes the scale tape 8 to function as a scale to be read by the optical detector as a whole.

As illustrated in FIG. 4, when the thickness of the scale tape 8 is denoted by t, the thickness of the protective layer 81 is denoted by t1, the thickness of the metal layer 82 is denoted by t2, and the thickness of the adhesive layer 83 is denoted by t3, the thicknesses t1 and t2 are each preferably 10 μm or more. In the present embodiment, the scale tape 8 having the thicknesses t1 and t2 of 25 μm and the thickness t3 of 5 μm is used. Therefore, the thickness of the end of the intermediate transfer belt 10 is formed thicker than other portions by the thickness t of the scale tape 8.

In the present embodiment, the scale tape 8 is bonded to the inner surface 10b of the intermediate transfer belt 10, but a scale mark M may be directly formed on the inner surface 10b by a laser processing machine or the like to form a scale. In the present embodiment, the scale tape 8 is provided on the entire circumference of the intermediate transfer belt 10, but the scale tape 8 may be provided on a part of the intermediate transfer belt 10 in the moving direction.

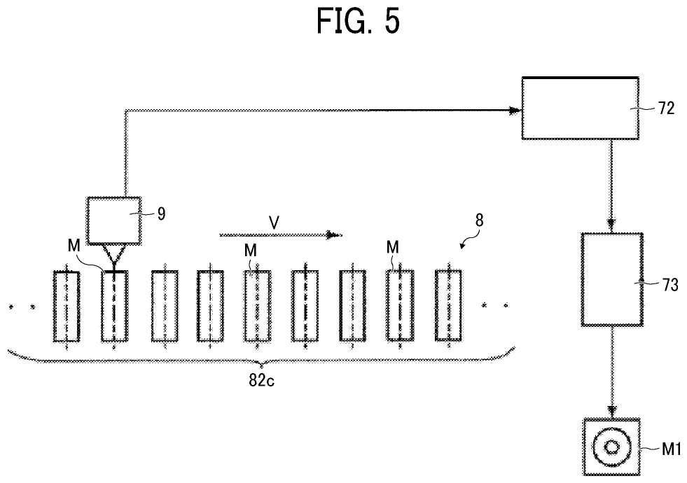

As illustrated in FIG. 5, the scale sensor 9 as a detector is disposed to face the scale mark M, and is connected to the drive control device 72 as a control module via a signal line. The scale sensor 9 sequentially detects the scale marks M on the intermediate transfer belt 10 and outputs a detection signal to the drive control device 72. That is, the scale sensor 9 has a function of detecting and reading the scale tape 8 which is a scale.

The drive control device 72 is connected to the drive motor M1 via the motor drive circuit 73, and has a function of controlling the operation of the drive motor M1 to control the belt traveling speed. As will be described later, the drive control device 72 acquires position data and the like for correcting the pitch of the scale mark M from the detection signal of the scale sensor 9, and, for example, inputs the target position data to the motor drive circuit 73 to control the belt traveling speed of the intermediate transfer belt 10. As described above, the drive control device 72 appropriately outputs a signal to the motor drive circuit 73 based on the position information and the like of the intermediate transfer belt 10 detected by the scale sensor 9, drives the drive motor M1 by the motor drive circuit 73, and performs feedback control on the belt traveling speed of the intermediate transfer belt 10.

Detection of the scale mark M by the scale sensor 9 will be described with reference to FIGS. 6A to 6C.

FIG. 6A is a plan view of a scale mark M formed on the scale tape 8, FIG. 6B is a side perspective view illustrating a configuration and an optical path of an optical system of the scale sensor 9, and FIG. 6C is a plan view of a detection surface of the scale sensor 9. The scale mark M is a reflection type mark, and as illustrated in the drawing, the scale mark M as a reflection portion and the light shielding portion S1 are alternately formed along the belt traveling direction V on an outer peripheral face of the intermediate transfer belt 10.

The scale sensor 9 has a light emitting element 91 such as an LED, a collimator lens 92, a slit mask 93 (see FIG. 6B), a light receiving window 94 formed of a transparent cover such as glass or a transparent resin film, a light receiving element 95 such as a phototransistor, and the like, which are secured to respective portions of the housing 90.

When the light emitting element 91, which is a light source of the scale sensor 9 emits light, the light passes through the collimator lens 92 to become a parallel light flux, passes through multiple slits 93a parallel to the scale mark M of the slit mask 93 illustrated in FIG. 6C, is divided into multiple light beams LB, and the scale tape 8 on the intermediate transfer belt 10 is irradiated therewith. A part of the multiple light beams LB is reflected by the scale mark M, the reflected light is received by the light receiving element 95 through the light receiving window 94, and the light receiving element 95 converts a change (intensity) in brightness of the reflected light into an electrical signal. In this manner, the scale sensor 9 detects the scale mark M by sensing the intensity of the reflected light by the light receiving element 95, and outputs the presence or absence of the scale mark M accompanying the movement of the intermediate transfer belt 10 as a continuously modulated analog alternating signal.

In the scale tape 8 provided at the end of the intermediate transfer belt 10, contaminants such as paper dust or toner adhere with use, for example, so that light reflectivity may be significantly deteriorated. In this case, although the degree of reduction in the light reflectivity of the scale tape 8 varies, if the light reflectivity falls below a certain level detectable by the scale sensor 9, the scale mark M of the scale tape 8 cannot be detected by the scale sensor 9, which may cause reading failure.

As a result of the scale mark M not being detected by the scale sensor 9 as described above, the moving speed of the intermediate transfer belt 10 cannot be accurately controlled, and a defect such as color deviation may occur due to a large influence on image forming.

For the reasons described above, it is desirable to periodically clean the scale tape 8 or the scale sensor 9 to remove the adhered contaminants. When the scale sensor 9 is cleaned using a dedicated cleaner, it is assumed that the cleaner is disposed in contact with the scale sensor 9. However, since a variation in the positional relationship between the cleaner and the scale sensor 9 causes a cleaning failure, relative positional accuracy between the cleaner and the scale sensor 9 is provided.

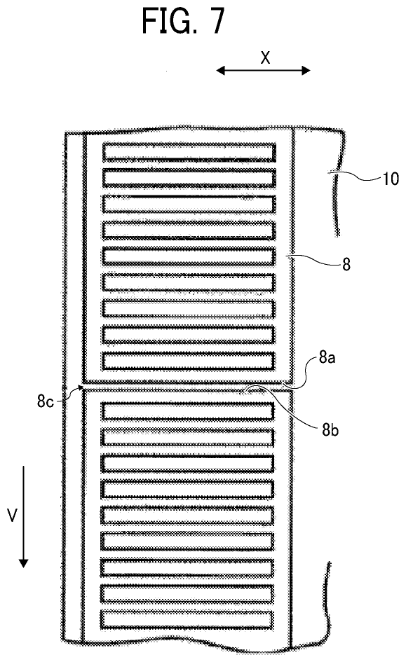

Further, since the scale tape 8 that has been attached to the inner surface 10b of the end of the intermediate transfer belt 10 is not an endless shape, and is a cut band-shaped type, a joint 8c is formed between the end 8a at the start of attachment and the end 8b at the end of attachment as illustrated in FIG. 7. Then, when toner, paper dust, or the like enters the joint 8c, adhesion failure of the scale tape 8 occurs, lifting occurs at the end 8a and the end 8b of the scale tape 8 over time, and the scale tape 8 reaches the end of its life before reaching the predetermined durability time of the intermediate transfer unit 6, and the intermediate transfer belt 10 may be forced to be replaced.

Therefore, there is a technique in which rotating brush (indicated by reference numeral 60 in FIG. 3) with bristles implanted on a roller that stretches the intermediate transfer belt is disposed on the upstream side of the scale sensor to clean the scale tape and a technique in which the intermediate transfer belt is sandwiched by a bracket provided with a front and back integrated brush disposed on the downstream side of the scale sensor.

Therefore, a technique for solving such various disadvantages will be described below as an embodiment.

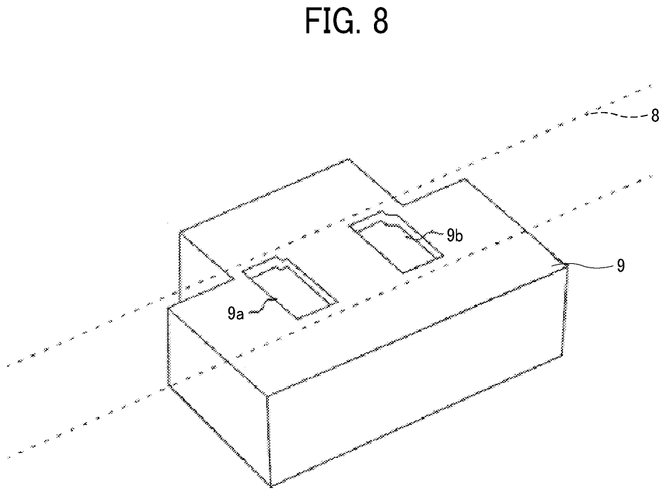

FIG. 8 is a schematic view illustrating a scale sensor 9 which is a detector for detecting the scale tape 8 which is the above-described scale. The scale sensor 9 includes a reader 9a on the upstream side and a reader 9b on the downstream side, and the two readers optically read the movement amount of the scale tape 8. In the scale sensor 9, an upper surface portion on which the readers 9a and 9b are provided is a belt sliding surface of the intermediate transfer belt 10. Examples of a structure of the sliding surface include a structure having a member with felt-like bristles implanted, a structure in which bristles are not implanted and two ribs are provided protruding in a direction parallel to the scale tape 8, and the like, and the sliding surface is arranged to be in contact with the scale tape 8 provided on the intermediate transfer belt 10 which is driven to travel. At a position facing the scale sensor 9 with the intermediate transfer belt 10 interposed therebetween, a holding component that comes into contact with the front surface side of the intermediate transfer belt 10 and sandwiches the intermediate transfer belt 10 with felt-like bristles, sponge, or the like is provided. The action of the holding component causes the intermediate transfer belt 10 to be sandwiched and pressed so that the distance to the scale sensor 9 is constant without fluttering in the vertical direction.

Since the scale sensor 9 optically reads the scale mark M provided on the scale tape 8, the readers 9a and 9b are respectively disposed in recesses recessed from the sliding surface so as not to be scratched or smeared by traveling of the intermediate transfer belt 10. A transparent protective member such as Mylar is provided on the surface of each of the recesses where the readers 9a and 9b are respectively disposed to prevent contaminants such as toner or paper dust from entering the recesses portions. However, in a case where the inside of the apparatus body is heavily contaminated, there is a case where contaminants are deposited in the recess, and there is a possibility that the scale sensor 9 cannot optically read the scale tape 8. In such a case, an operator such as a service person removes the intermediate transfer belt 10 and removes the contaminants deposited in the recess with air, a soft cloth, or the like.

The contaminants deposited in the recess of the scale sensor 9 are mainly deposited from the surface side of the intermediate transfer belt 10 or the photoconductor 40 side. This is because the toner directly dropped from the developing unit or the photoconductor unit or the untransferred toner generated at the time of the primary transfer and the secondary transfer is peeled off from the surface of the intermediate transfer belt 10 and dissipated to the inside of the apparatus body, and is deposited as toner contamination on the surface end of the intermediate transfer belt 10. Then, the toner contamination adhering to the surface end of the intermediate transfer belt 10 is rubbed off by being removed by the airflow, a seal member in contact with the belt surface, or the like, and goes around to the back surface side of the intermediate transfer belt 10, and the contaminants are deposited on the back surface of the intermediate transfer belt 10. Then, the contaminants deposited on the back surface contaminate the scale tape 8 and the scale sensor 9 provided on the back surface of the intermediate transfer belt 10, and finally, the scale sensor 9 cannot optically read the scale tape 8, and belt speed control by the scale sensor 9 cannot be performed. Therefore, an operator removes contaminants periodically or at the time of deposition of the contaminants.

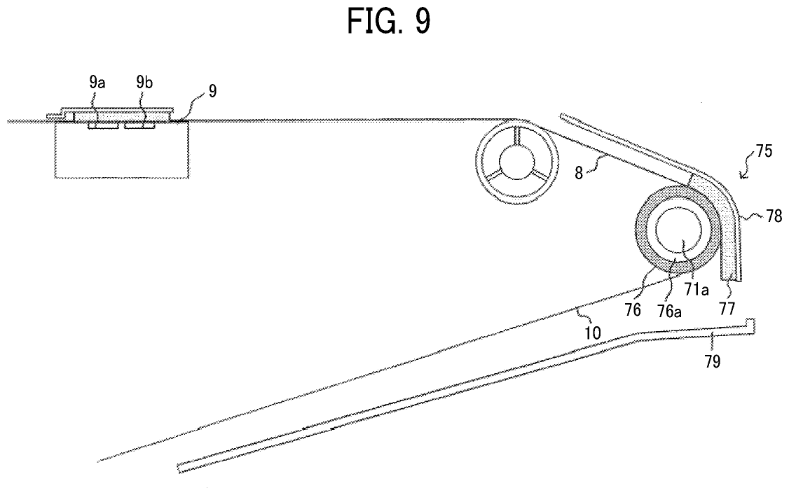

FIG. 9 illustrates a belt cleaner 75. In FIG. 9, the belt cleaner 75 has a member that scrapes off contaminants deposited on the surface of the intermediate transfer belt 10 and the contaminants reaching the back surface of the intermediate transfer belt 10, and can constantly clean the scale tape 8 and the scale sensor 9 to remove contaminants therefrom. As a result, it is possible to constantly maintain the detection level for the scale sensor 9 to read the scale tape 8. As a specific configuration, the belt cleaner 75 includes a first cleaner that cleans the back surface of intermediate transfer belt 10 and a scale tape 8 provided on the back surface of intermediate transfer belt 10, and a second cleaner that cleans the surface of the intermediate transfer belt 10.

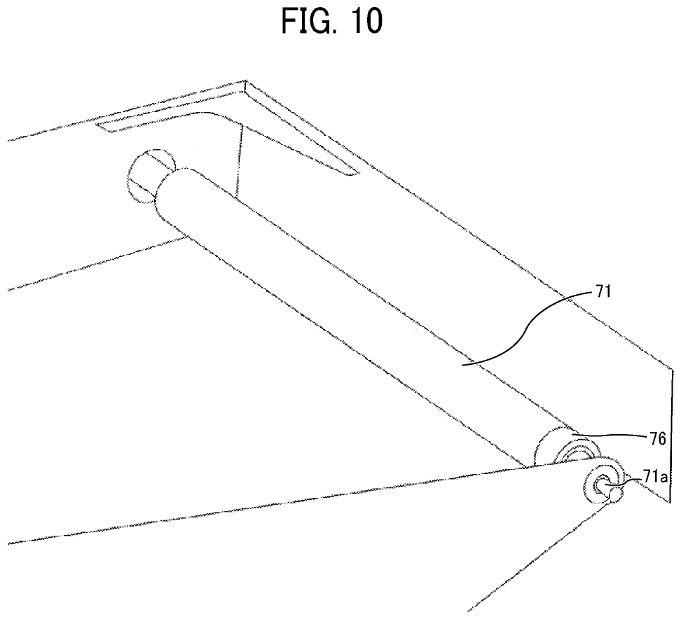

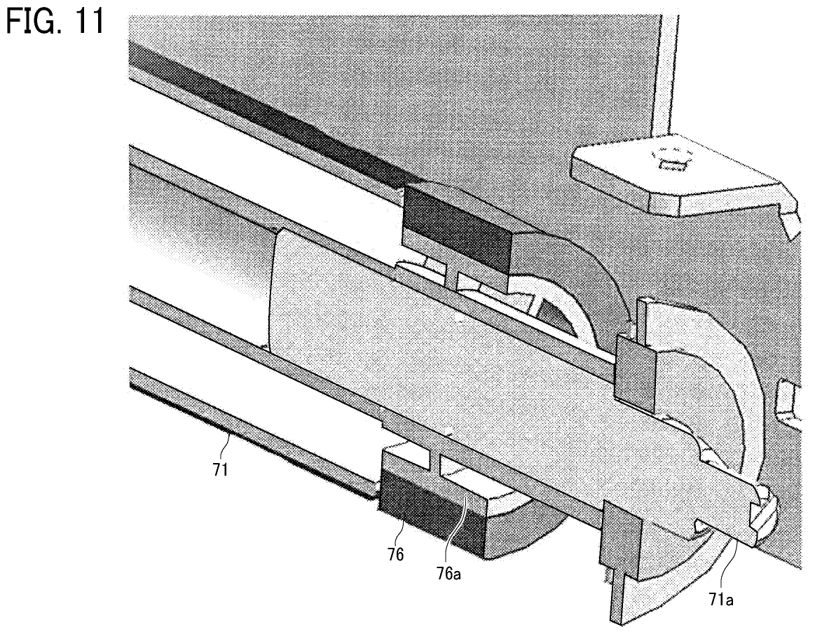

The first cleaner is a brush roller 76 rotatably supported by a roller shaft 71a of the driving roller 71. As illustrated in FIG. 10, the brush roller 76 is disposed at one side end of the driving roller 71, and an arrangement position of the brush roller 76 corresponds to an arrangement position of the scale tape 8 provided inside the intermediate transfer belt 10. As illustrated in FIG. 11, the brush roller 76 is secured to a brush collar 76a rotatably supported by the roller shaft 71a, and the surface of the brush roller 76 has a brush with bristles implanted for removing contaminants adhering to the scale tape 8. The brush roller 76 receives a driving force from the intermediate transfer belt 10 on which the surface of the brush travels, and rotates together with the brush collar 76a as the intermediate transfer belt 10 is driven to travel. The brush roller 76 is an example of a first cleaner.

As described above, the brush roller 76 can rotate independently of the driving roller 71 without being affected by the rotation speed of the driving roller 71. For this reason, when the surface of the brush comes into contact with the intermediate transfer belt 10 and is driven to rotate, even if a speed difference is generated between the surface of the brush and the rotation speed of the driving roller 71, the influence of the rotation unevenness caused by the speed difference is not transmitted to the driving roller 71. Therefore, it is possible to prevent the occurrence of the rotation unevenness in the driving roller 71, and it is possible to prevent the occurrence of the abnormal image due to the occurrence of the rotation unevenness in the driving roller 71. The driving roller 71 is an example of a predetermined roller in the present embodiment.

In addition, since the stationary brush roller 76 receives the driving force from the intermediate transfer belt 10 and rotates, an effect of strongly scraping off the contaminants against the intermediate transfer belt 10 can be expected. Therefore, the accumulated contaminants can be scraped off. The surface of the brush of the brush roller 76 is set to have a biting amount of about 0.3 to 0.5 mm with respect to the intermediate transfer belt 10. As a result, at the moment when the surface of the brush bites into the intermediate transfer belt 10, the biting causes the radius of the brush roller 76 to change, thereby constantly changing the moving speed of the surface of the brush. Therefore, it is possible to obtain a speed difference between the brush and the back surface of the belt at the time of being in contact with the intermediate transfer belt 10, so that even in a state of being driven to rotate, the effect of scraping off the contaminants can be obtained.

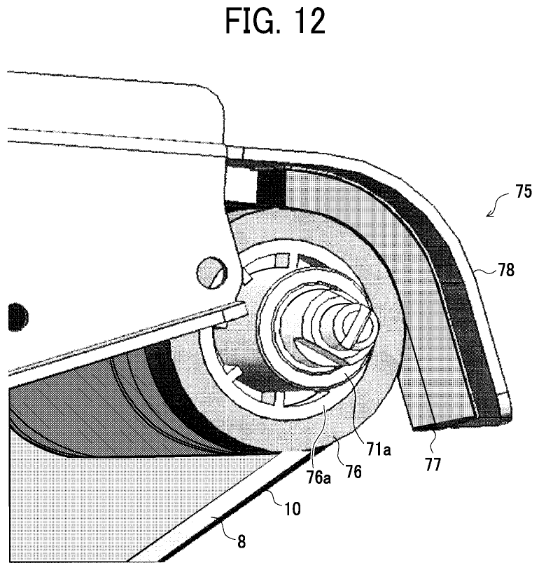

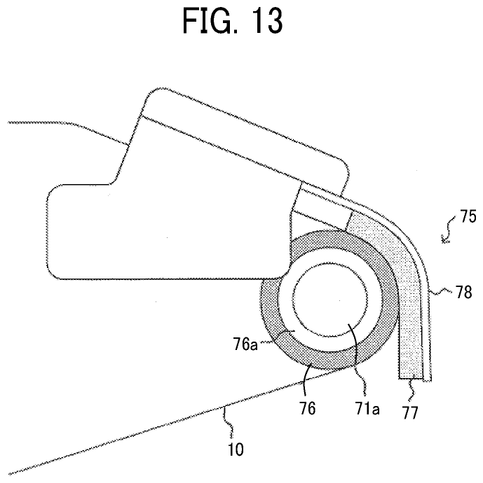

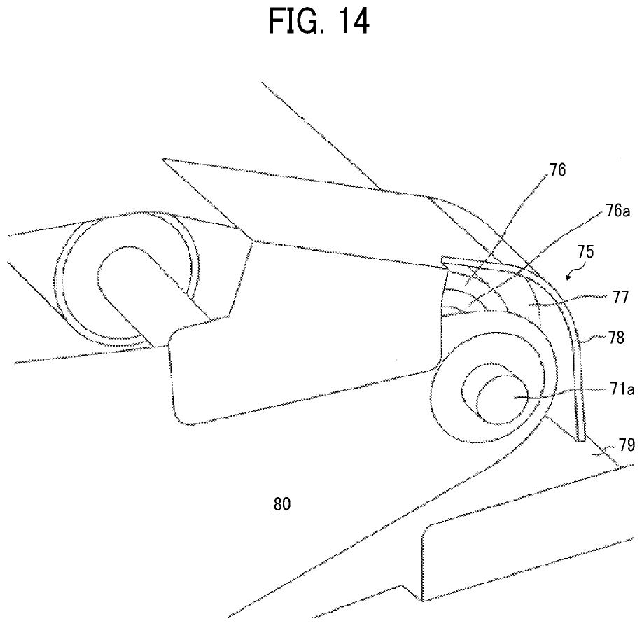

The second cleaner is a cleaning brush 77 that is disposed to face the brush roller 76 via the intermediate transfer belt 10 and comes into contact with the outer peripheral face of the intermediate transfer belt 10 to clean the outer peripheral face. As illustrated in FIGS. 12, 13, and 14, the cleaning brush 77 is secured to a bracket 78 provided at a position away from the outer peripheral face of the intermediate transfer belt 10 by a predetermined distance, and an arrangement position thereof corresponds to an arrangement position of the scale tape 8 provided inside the intermediate transfer belt 10. The bracket 78 formed in a curved surface shape has, on its inner surface side, an attachment surface formed in an arc shape concentric with the rotation axis of the driving roller 71 to which the cleaning brush 77 is attached. That is, the surface of the cleaning brush 77 secured to the bracket 78 is arranged to have a surface having substantially the same curvature as the surface of the driving roller 71, that is, an outer peripheral face of the brush roller 76. The bracket 78 is attached to the side plate 80 (see FIG. 14) of the intermediate transfer unit 6. The cleaning brush 77 is an example of a second cleaner.

With the above configuration, the cleaning brush 77 including the brush having a rectangular cross section with bristles having the same length implanted on the entire surface of the cleaning brush 77 is secured to the bracket 78 by attaching or the like, so that the surface of the brush of the cleaning brush 77 can bite into the surface of the intermediate transfer belt 10 wound around the driving roller 71 with the same length. The biting amount of the cleaning brush 77 with respect to the intermediate transfer belt 10 on the surface of the brush is set to about 0.3 to 0.5 mm similarly to the brush roller 76. As a result, it is possible to maintain an equal biting amount in the entire range where the cleaning brush 77 bites into the intermediate transfer belt 10, and it is possible to maintain a stable ability to scrape the contaminants.

In the above configuration, the shape of the cleaning brush 77 can be simplified, and the process of aligning the bristles length of the surface of the brush is simplified, so that the manufacturing cost can be reduced. Since the cleaning brush 77 is disposed in a securing state with respect to the intermediate transfer belt 10 that is driven to travel, a speed difference when the intermediate transfer belt 10 travels constantly occurs between the intermediate transfer belt 10 and the cleaning brush 77, so that the surface of the intermediate transfer belt 10 can be satisfactorily cleaned.

The contaminants scraped off the surface of the intermediate transfer belt 10 by the cleaning brush 77 fall and are stored in a storage member 79 disposed below a portion where the brush roller 76 and the cleaning brush 77 are in contact with each other via the intermediate transfer belt 10. As illustrated in FIG. 9, the storage member 79 is formed in a size that can receive a wide range of contaminants falling from the surface of the intermediate transfer belt 10, and is disposed at a position where the falling contaminants can be reliably received. The storage member 79 is detachably attached to a frame of the intermediate transfer unit 6, and a worker such as a service person periodically cleans the storage member 79, so that it is possible to prevent the contaminants stored in the storage member 79 from contaminating the inside of the apparatus body, the conveyance path, and the like.

Most of the contaminants adhere to the surface of the intermediate transfer belt 10, and most of the contaminants adhering to the surface of the intermediate transfer belt 10 are removed by cleaning with the cleaning brush 77. Therefore, the amount of contaminants reaching from the front surface side to the back surface side of the intermediate transfer belt 10 is a minimum amount. As a result, it is possible to continuously perform the natural cleaning operation without causing the contamination at a level that affects the formed image and the traveling of the intermediate transfer belt 10 without providing a mechanism or the like that collects the contaminants adhering to the surface of the brush with respect to the brush roller 76 that cleans the back surface of the intermediate transfer belt 10.

In the present embodiment, examples of the material used for the brushes of the brush roller 76 and the cleaning brush 77 include synthetic resin fibers and PET resin having electric conductivity. In the present embodiment, bristles of fibers made of PET resin having electric conductivity are implanted into a resin collar portion or a PET sheet to form a brush, and a hair foot length is 4 to 6 mm and a biting amount is about 0.3 to 0.5 mm.

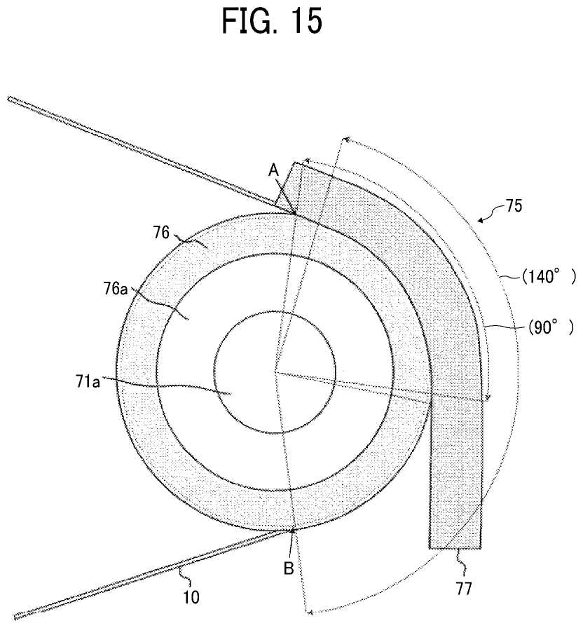

Next, a winding angle of the intermediate transfer belt 10 with respect to the driving roller 71 in the present embodiment will be described with reference to FIG. 15. In the present embodiment, the angle from the contact start point A to the contact end point B between the intermediate transfer belt 10 and the driving roller 71 is the winding angle of the intermediate transfer belt 10 with respect to the driving roller 71. Similarly, the winding angle of the intermediate transfer belt 10 with respect to the brush roller 76 as the first cleaner is substantially the same as the winding angle of the intermediate transfer belt 10 with respect to the driving roller 71 because the driving roller 71 and the brush roller 76 are coaxially disposed, and the diameter of the brush roller 76 is slightly larger than the diameter of the driving roller 71. In the present embodiment, the winding angle of the intermediate transfer belt 10 with respect to the driving roller 71 and the winding angle of the intermediate transfer belt 10 with respect to the brush roller 76 are about 140 degrees.

As the winding angle of the intermediate transfer belt 10 with respect to the brush roller 76 described above is larger, the contact time and the contact distance between the brush roller 76 and the intermediate transfer belt 10 are longer, and the brush roller 76 can continuously receive a larger driving force from the intermediate transfer belt 10, so that it is possible to increase the cleaning performance for the back surface of the intermediate transfer belt 10.

If there are no members facing each other that clean the surface with the winding angle between the brush and the belt, which are cleaners, being about 30 degrees, the contact time and the contact distance between the brush and the belt are short, the brush roller 76 cannot receive the sufficient driving force transmitted from the belt, and cleaning performance is smaller than that of the configuration of the present embodiment. Therefore, in this configuration, in a state where the inside of the apparatus body is heavily contaminated, the deposition rate of the contaminants exceeds the cleaning rate, and thus it is difficult to maintain the cleanliness of the scale tape to such an extent that reading by the scale sensor can be sufficiently continued.

However, in the configuration of the present embodiment, the winding angle of the intermediate transfer belt 10 with respect to the brush roller 76 is 90 degrees or more, and the brush roller 76 can continue to receive a larger driving force from the intermediate transfer belt 10. As a result, a larger cleaning performance can be obtained as compared with the configuration having the winding angle of 30 degrees, for example, so that the cleanliness of the scale tape 8 can be maintained to such an extent that reading by the scale sensor 9 can be sufficiently continued.

As a configuration in which the operational effects of the present embodiment can be sufficiently exhibited, the winding angle between the roller and the belt is 90 degrees or more as described above, and thus as illustrated in FIG. 2, the driving roller 71 or the roller 68 is suitable as the predetermined roller in the present embodiment.

As the winding angle of the belt with respect to the cleaner increases, the cleaning performance of the cleaner is improved, but the influence of the cleaner on the traveling of the belt increases in proportion thereto. When the influence is equal to or greater than a certain level, rotation unevenness or the like of the cleaner destabilizes the traveling speed of the belt, and image unevenness or the like associated with belt speed variation occurs in the output image. The occurrence of the image unevenness associated with the speed variation is likely to occur at the position where the belt is slackened, the upstream position of the driving roller, and the downstream position of the scale sensor. At such a position, the belt flutters, and the value at which the scale sensor reads the scale tape becomes unstable, and the image is likely to be affected.

In order to prevent such a disadvantage from occurring, in the present embodiment, the first cleaner that cleans the inner surface side of the belt is disposed coaxially with the driving roller around which the belt is wound at an angle of 90 degrees or more, and the second cleaner that is in contact with an outer peripheral face of the belt is disposed at a portion facing the first cleaner.

With this configuration, the belt can be sufficiently wound around the first cleaner, and the second cleaner can be disposed at a location where the belt is most unlikely to be loosened to clean the belt. As a result, it is possible to provide a belt cleaner that can continuously prevent the occurrence of an abnormal image without affecting the traveling performance and the rotational performance of the belt and the driving roller even when a contact length, a contact time, and a biting amount sufficient to prevent contamination of the scale tape are applied to the belt.

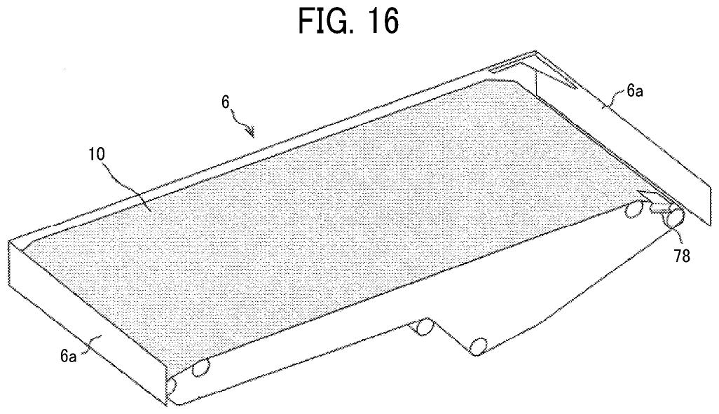

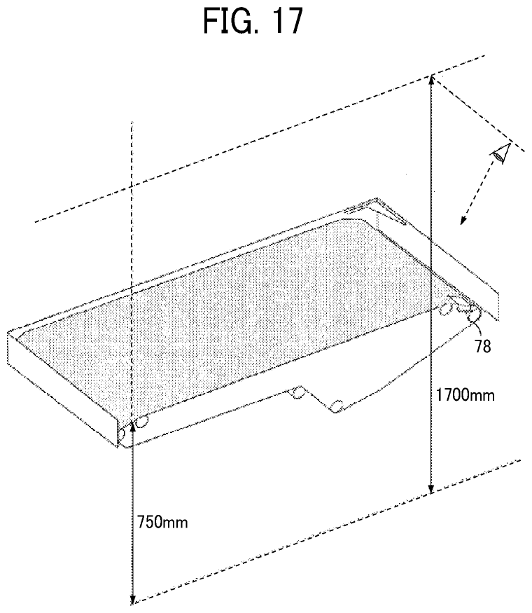

FIGS. 16 and 17 are views illustrating a method of attaching and detaching the intermediate transfer belt 10 in the present embodiment. The intermediate transfer unit 6 is supported at ends thereof in the belt traveling direction by respective slide rail holding members 6a provided to the apparatus body 2, and is secured to the slide rail holding member 6a by face plates provided on a front side of each of the slide rail holding members 6a in FIG. 16, and is positioned in the front-rear direction with respect to the apparatus body 2.

When the intermediate transfer belt 10 is attached to and detached from the intermediate transfer unit 6, a face plate is removed to bring the intermediate transfer belt 10 into the state illustrated in FIG. 16. From this state, the tension roller 15 that applies tension to the intermediate transfer belt 10 is removed to form a slack sufficient for the removal in the intermediate transfer belt 10.

On the outer side of the intermediate transfer belt 10, a holding component, a storage member 79, and the like provided at a position facing the scale sensor 9 are disposed. After these members are removed, an operator such as a service person grips both ends of the intermediate transfer belt 10 and pulls out the intermediate transfer belt 10 to the front side in the horizontal direction with respect to the intermediate transfer unit 6, whereby the intermediate transfer belt 10 can be removed.

As illustrated in FIG. 17, the intermediate transfer belt 10 is disposed at a height of about 750 mm from the installation surface of the color copying machine 1, and an operator having a height of about 1700 mm who is a general adult male performs replacement work of the intermediate transfer belt 10 looks down the intermediate transfer belt 10 from obliquely above, to remove the intermediate transfer belt 10 from the intermediate transfer unit 6.

Since the replacement work of the intermediate transfer belt 10 is performed in the above-described posture, a component disposed in the lower portion of the intermediate transfer unit 6 may be left in a blind spot for the operator. If a remove operation of the intermediate transfer belt 10 is performed in a state where the component to be removed has been left without being removed, the intermediate transfer belt 10 and the component may interfere with each other, and damage such as flaw and breakage may occur, and replacement may be performed. Some of the intermediate transfer belts 10 are made of high-gloss polyimide having a thickness of about 0.6 mm or have an elastic layer on the surface, but all of them are likely to be broken or scratched and are expensive, so that replacement work is to be carefully performed.

In the present embodiment, the cleaning brush 77, which is the second cleaner, is disposed on the surface side of the intermediate transfer belt 10 and on the opposing portion of the brush roller 76, which is the first cleaner disposed coaxially with the driving roller 71, via the intermediate transfer belt 10. Therefore, when the intermediate transfer belt 10 is attached and detached, the cleaning brush 77 and the bracket 78 that secures the cleaning brush 77 are removed from the intermediate transfer unit 6. The cleaning brush 77 that is disposed below the intermediate transfer belt 10 may be in a blind spot for the operator and has been left without being removed at the time of replacement work, as described above, and the expensive intermediate transfer belt 10 may be damaged.

In general, in an image forming apparatus in which a transfer sheet is conveyed in a horizontal direction and multiple photoconductors is arranged in the horizontal direction, an intermediate transfer unit is disposed to face each photoconductor, and thus has a horizontally long inverted triangular shape. At that time, in order to obtain a frictional force for driving the intermediate transfer belt, when the driving roller is disposed at a position where a sufficient winding angle of the belt is obtained, the driving roller is inevitably disposed at either one of both ends of the intermediate transfer unit, that is, both ends of the inverted triangular shape. Therefore, by disposing the cleaning brush 77 and the bracket 78 holding the cleaning brush 77 illustrated in the present embodiment on the upper portion of the intermediate transfer belt 10, which is an opposing portion of the driving roller 71, it is possible to prevent the cleaning brush 77 from being disposed in a blind spot for the operator at the time of removal operation for the intermediate transfer belt 10.

When the intermediate transfer belt 10 is removed from the intermediate transfer unit 6, the operator grips both ends of the intermediate transfer belt 10 and removes the intermediate transfer belt 10 toward the front side in the horizontal direction. Therefore, when the cleaning brush 77 and the bracket 78 are disposed at either end of the intermediate transfer unit 6, the cleaning brush 77 and the bracket 78 are disposed in the vicinity of the position where the operator grips the intermediate transfer belt 10 during the attaching and detaching work, so that the operator can easily notice if the cleaning brush 77 and the bracket 78 have been left without being removed during the attaching and detaching work of the intermediate transfer belt 10. As a result, it is possible to reliably prevent breakage of the intermediate transfer belt 10 at the time of replacement work due to the fact that the component to be removed has been left without being removed.

In the above embodiments, an exemplary using a color copying machine that forms a full-color image has been given as the image forming apparatus. Any image forming apparatus to which the present embodiment can be applied is not limited to the example, and thus the present embodiment can be applied to, for example, a printer, a facsimile, or a multifunction peripheral.

The above-described embodiments describe a configuration in which the transfer sheet S is used as a recording medium on which an image is formed. However, the transfer sheet S is not limited to a recording paper, and includes thick paper, a postcard, a rolled sheet, an envelope, plain paper, thin paper, pigment coated paper (coat paper, art paper, and the like), tracing paper, an overhead projector transparency (OHP) sheet, OHP film, a resin film, and any other sheet-shaped material on which an image can be formed.

A belt conveyor includes: multiple rollers (61-71) including a predetermined roller (71); a belt (10) wound around the multiple rollers (71-71), the belt (10) traveling in a traveling direction (V); a scale (8) on an inner peripheral face of the belt (10), the scale (8) disposed in a vicinity of an end of the belt in a width direction orthogonal to the traveling direction, a detector (9) to detect the scale (8) on the belt (10); circuitry (72) configure to control a traveling speed of the belt (10) by reflecting an output from the detector; a first cleaner (76) on the predetermined roller (71), around which the belt (10) is wound at an angle of 90 degrees or more, and the first cleaner (76) contacting the scale (8) to clean the scale; and a second cleaner (77): facing the first cleaner (76) via the belt (10); and contacting an outer peripheral face of the belt (10) to clean the outer peripheral face.

The first cleaner (76) includes a rotator coaxial with the predetermined roller (71). The predetermined roller (71) includes a driving roller to drive the belt (10). The second cleaner includes: a bracket secured at a fixed position; and a brush on an inner face of the bracket, the brush in contact with the outer peripheral face of the belt at the fixed position. The second cleaner (77) includes: a first part faces an upper part of the belt; and a second part faces a side part of the belt. The second cleaner (77) has an inner surface having a curvature same as a curvature of an outer peripheral face of the predetermined roller. The rotator of the first cleaner (76) includes a brush on an outer surface of the rotator. The rotator is: relatively rotatable with respect to the predetermined roller; and in contact with the scale on the belt and rotated by the belt. The bracket secured at the fixed position includes the brush on the inner face of the bracket, and the fixed position is at a portion of the belt where the belt (10) is wound around the predetermined roller (71) at an angle of 90 degrees or more.

An image forming apparatus includes the belt conveyor. A belt cleaner includes: a first cleaner (76) on a predetermined roller (71), around which a belt (10) is wound at an angle of 90 degrees or more, and the first cleaner (76) contacting a scale (8), which is attached on an inner peripheral face of the belt (10), to clean the scale; and a second cleaner (77): facing the first cleaner (76) via the belt (10); and contacting an outer peripheral face of the belt (10) to clean the outer peripheral face.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

According to the present embodiment, it is possible to provide the belt cleaner that can maintain the cleanliness of the scale to such an extent that reading by the detector can be sufficiently continued since a larger cleaning capability can be obtained as compared with the other configuration, and can maintain the scale provided on the back surface of the belt at an optically readable level.

Aspects of the present embodiment are, for example, as follows.

### Aspect 1

According to Aspect 1, a belt cleaner is provided in a belt conveyor, the belt conveyor including a belt of an endless shape that is stretched around multiple rollers and is traveling in a traveling direction by receiving a driving force from a driver, a scale provided on an inner peripheral face of the belt in a vicinity of at least one end in a width direction orthogonal to the traveling direction, a detector that detects the scale, and a control module that controls a traveling operation of the belt on a basis of a detection result of the scale by the detector, and the belt cleaner includes: a first cleaner that is provided on a predetermined roller around which the belt among the multiple rollers is wound at an angle of 90 degrees or more and that is in contact with the scale to clean the scale; and a second cleaner that is disposed facing the first cleaner via the belt and comes into contact with an outer peripheral face of the belt to clean the outer peripheral face.

### Aspect 2

According to Aspect 2, in the belt cleaner of Aspect 1, the first cleaner is a rotator provided coaxially with the predetermined roller.

### Aspect 3

According to Aspect 3, in the belt cleaner of Aspect 1 or Aspect 2, the predetermined roller is the driver.

### Aspect 4

According to Aspect 4, in the belt cleaner of any one of Aspects 1 to 3, the second cleaner is a secured member that is in contact with the outer peripheral face at a fixed position.

### Aspect 5

According to Aspect 5, in the belt cleaner of any one of Aspects 1 to 4, the second cleaner is disposed above the belt.

### Aspect 6

According to Aspect 6, in the belt cleaner of any one of Aspects 1 to 5, the second cleaner is configured to have a surface having substantially a same curvature as an outer peripheral face of the predetermined roller.

### Aspect 7

According to Aspect 7, in the belt cleaner of Aspect 2, the rotator includes a brush on a surface of the rotator.

### Aspect 8

According to Aspect 8, in the belt cleaner of Aspect 2 or 7, the rotator is relatively rotatable with respect to the predetermined roller, and comes into contact with the scale provided on the belt that travels, and is driven to rotate.

### Aspect 9

According to Aspect 9, in the belt cleaner of Aspect 4, the secured member includes a brush on a surface of the secured member.

### Aspect 10

According to Aspect 10, an image forming apparatus includes the belt conveyor and the belt cleaner of any one of Aspects 1 to 9.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

The effects in the present embodiment correspond to most favorable effects from the present embodiment. Thus, effects according to the present embodiment are not limited to the effects in the present embodiment.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A belt conveyor comprising:
multiple rollers including a predetermined roller;
a belt wound around the multiple rollers, the belt traveling in a traveling direction;
a scale on an inner peripheral face of the belt, the scale disposed in a vicinity of an end of the belt in a width direction orthogonal to the traveling direction,
a detector to detect the scale on the belt;
circuitry configured to control a traveling speed by reflecting an output from the detector;
a first cleaner on the predetermined roller, around which the belt is wound at an angle of 90 degrees or more, and the first cleaner contacting the scale to clean the scale; and
a second cleaner:
facing the first cleaner via the belt; and
contacting an outer peripheral face of the belt to clean the outer peripheral face.

2. The belt conveyor according to claim 1,
wherein the first cleaner includes a rotator coaxial with the predetermined roller.

3. The belt conveyor according to claim 1,
wherein the predetermined roller includes a driving roller to drive the belt.

4. The belt conveyor according to claim 1,
wherein the second cleaner includes:
a bracket secured at a fixed position; and
a brush on an inner face of the bracket, the brush in contact with the outer peripheral face of the belt at the fixed position.

5. The belt conveyor according to claim 4,
wherein the second cleaner includes:
a first part facing an upper part of the belt; and
a second part facing a side part of the belt.

6. The belt conveyor according to claim 5,
wherein the second cleaner has an inner surface having a curvature the same as a curvature of an outer peripheral face of the predetermined roller.

7. The belt conveyor according to claim 2,
wherein the rotator of the first cleaner includes a brush on an outer surface of the rotator.

8. The belt conveyor according to claim 2,
wherein the rotator is:
relatively rotatable with respect to the predetermined roller; and
in contact with the scale on the belt and rotated by the belt.

9. The belt conveyor according to claim 4,
wherein the bracket secured at the fixed position includes the brush on the inner face of the bracket, and
the fixed position is at a portion of the belt where the belt is wound around the predetermined roller at an angle of 90 degrees or more.

10. An image forming apparatus comprising the belt conveyor according to claim 1.

11. A belt cleaner comprising:
a first cleaner on a predetermined roller, around which a belt is wound at an angle of 90 degrees or more, and the first cleaner contacting a scale, which is attached on an inner peripheral face of the belt, to clean the scale; and
a second cleaner:
facing the first cleaner via the belt; and
contacting an outer peripheral face of the belt to clean the outer peripheral face.
